(19) United States
(12) Patent Application Publication
(10) Pub. No.: US 2026/0156386 A1
(43) Pub. Date: Jun. 4, 2026

(54) ADAPTIVE POWER REDUCTION READOUT FOR OVERFLOW PIXEL SENSORS

(71) Applicant: SEMICONDUCTOR COMPONENTS INDUSTRIES, LLC, Scottsdale, AZ (US)

(72) Inventor: Sergey VELICHKO, Boise, ID (US)

(73) Assignee: SEMICONDUCTOR COMPONENTS INDUSTRIES, LLC, Scottsdale, AZ (US)

(21) Appl. No.: 18/966,560

(22) Filed: Dec. 3, 2024

(51) Int. Cl. H04N 25/78; H04N 25/77

(52) U.S. Cl. CPC H04N 25/78; H04N 25/77

(57) ABSTRACT

Systems, devices, and methods are described to adaptively perform and/or skip one or more multi-gain pixel readout operations based on one or more pixel values and one or more threshold values. An image sensor may include readout circuitry having an adaptive readout control circuitry. The adaptive readout control circuitry may be configured to controllably disable one or more of the multi-gain readout operations based on a comparison of pixel values to the threshold values. The readout circuitry may compare a first threshold to a reset value from a high conversion gain readout operation, and a second threshold to an image value from a high conversion gain readout operation. The adaptive readout control circuitry may be configured to responsively disable one or more high conversion gain, medium conversion gain, and/or low conversion gain readout operations. The image sensor may determine a corresponding final pixel.

### BACKGROUND

This application relates generally to image sensors and, more particularly, to adapting pixel readout according to the illumination intensity of the imaged scene.

Image sensors with overflow pixels are designed to handle high-intensity light situations and reduce the risk of saturation or clipping in images. By handling excess light more effectively, overflow pixels can improve the dynamic range of the image sensor and enhance its ability to capture a broader range of light intensities. Such image sensors may facilitate high dynamic range (HDR) imaging. Overflow pixel image sensors may be used in a number of applications, such as advanced driver-assistance systems (ADAS), autonomous vehicles, surveillance systems, industrial inspection, and the like.

Overflow pixels may contain a photodiode (PD) configured to convert incident photons into electrical charge, and one or more storage structures adapted to store excess charge generated in higher-illumination settings. Overflow pixels may be adapted to provide multiple gain readouts, for example providing one or more pixel values at one or more gains, to cover the entire pixel signal range. For example, an exemplary overflow pixel may require six readouts, including three reset-level readouts and three corresponding image-level readouts, with each pair of reset and signal readouts at a different gain. The multiple values read from the pixel by respective readout circuitry may then be recombined, for example through linearization, to provide a single output HDR value. The recombination may be performed by downstream processing circuitry, such as an HDR pipeline circuitry.

The multiple pixel readout operations result in increased power consumption. In tightly packed cameras, the increased power may heat up the sensor and other camera electronics, resulting in degraded camera performance such as decreased low light performance, reduced dynamic range, and increased noise in transition, as some examples. The increased power consumption further results in more expensive camera designs, which in some cases may require active heat dissipation.

It would therefore be desirable to provide improved systems, devices, and methods for overflow pixel sensors to reduce power consumption.

### BRIEF DESCRIPTION OF DRAWING FIGURES

FIG. 1 is a block diagram of an exemplary image sensor, according to various embodiments.

FIG. 2 is a circuit diagram of an exemplary pixel, according to various embodiments.

FIG. 3 representatively illustrates a timing diagram for operating a pixel, according to various embodiments.

FIG. 4 is a schematic diagram of an exemplary readout circuitry, according to various embodiments.

FIG. 5 is a flowchart illustrating an exemplary adaptive readout method, according to various embodiments.

FIG. 6A representatively illustrates a charge distribution in a pixel under a high light condition, according to various embodiments.

FIG. 6B representatively illustrates readout operations not performed under a high light condition, according to various embodiments.

FIG. 7A representatively illustrates a charge distribution in a pixel under a low light condition, according to various embodiments.

FIG. 7B representatively illustrates readout operations not performed under a low light condition, according to various embodiments.

FIG. 8A representatively illustrates a charge distribution in a pixel under a medium light condition, according to various embodiments.

FIG. 8B representatively illustrates readout operations not performed under a medium light condition, according to various embodiments.

### BRIEF SUMMARY

Various embodiments relate to systems, devices, and methods for adaptively controlling multi-gain readout operations for image sensors.

In various embodiments, a method for multi-gain readout of a pixel of an image sensor may include obtaining a high conversion gain (HCG) reset value from the pixel, comparing the HCG reset value to a first threshold, in response to the HCG reset value being less than the first threshold, disabling an HCG image value readout operation (RO) and a medium conversion gain (MCG) RO, and in response to the HCG reset value being greater than or equal to the first threshold: obtaining an HCG image value from the pixel, comparing the HCG image value to a second threshold, in response to the HCG image value being less than the second threshold, disabling a low conversion gain (LCG) RO, and in response to the HCG image value being greater than or equal to the second threshold, disabling the MCG RO and the LCG RO.

In various embodiments, an image sensor may include a pixel having an output and configured to provide, on the output, a pixel value; and a readout circuitry coupled with the output of the pixel, wherein the readout circuitry comprises: a memory configured to provide a first threshold, and a plurality of readout components, wherein the plurality of readout components comprises a sample and hold circuitry configured to store a sampled value corresponding to the pixel value, a comparator coupled with the memory and the sample and hold circuitry and configured to compare the sampled value to the first threshold and responsively output a first comparison result, and an adaptive readout control circuitry coupled with the comparator and configured to controllably disconnect at least one of the plurality of readout components from a supply voltage in response to the comparison result.

In various embodiments, an adaptive readout control circuitry configured to couple with a readout circuitry of an image sensor may include a first input configured to receive, from the readout circuitry, a digital value corresponding to a pixel value, a second input configured to receive a first threshold, and an output configured to couple with the readout circuitry, wherein the adaptive readout control circuitry is configured to: compare the digital value to the first threshold, and controllably disable, via the output and based on the comparison, the readout circuitry during one or more pixel readout operations (RO).

These and other examples are described in increasing detail below.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, overflow pixel sensor devices and methods are provided that beneficially reduce power consumption, improve performance, and decrease camera system cost. Exemplary image sensor devices and methods may logically analyze sequential readout analog-to-digital conversions of the pixel signal values to determine whether to shut down certain readout circuitry for part or the full duration of the remaining readout time.

According to various embodiments, exemplary image sensor devices and methods may result in readout power reduction of about one-third to about two-thirds, depending on the brightness mix of the imaged scene. In some cases, the readout power may comprise about half the power used by the image sensor. For example, a typical eight-megapixel automotive HDR image sensor may perform multi-gain overflow HDR pixel readouts and may consume about 650 mW of power. An image sensor according to the embodiments described herein, performing multi-gain overflow HDR pixel readouts, may consume about 300 mW to 400 mW of power. The reduced power consumption results in improved performance and facilitates cheaper camera designs, such as providing the ability to use plastic casings.

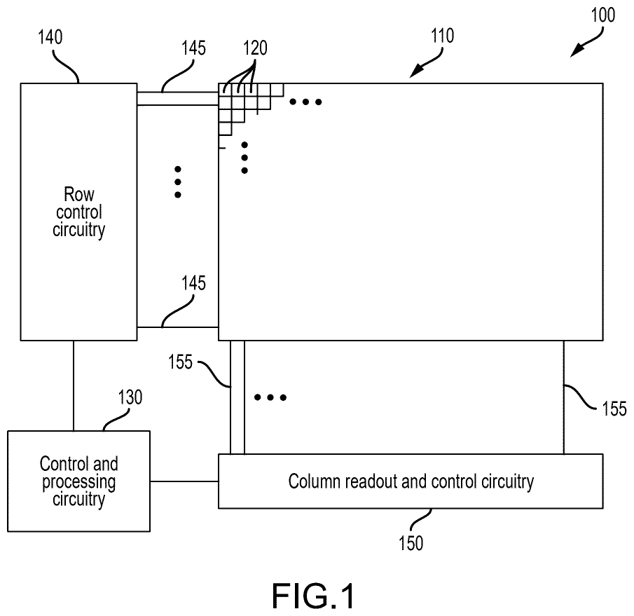

FIG. 1 illustrates a block diagram of an exemplary image sensor 100. In some embodiments, the configuration of the image sensor, the arrangement of various components therein, and the operation of the various components may be similar, in some aspects, to that which is described with respected to U.S. Pat. No. 11,722,794, which is incorporated herein by reference. The embodiments described herein, however, may be applied to other configurations of image sensors, pixel arrays, pixels, and the like. In some embodiments, the image sensor 100 may be implemented as a semiconductor device on a single substrate, stacked substrates, system-on-chip, or the like.

In some embodiments, the image sensor 100 may include a pixel array 110 having multiple image sensor pixels 120. The pixels 120 may be arranged in any suitable manner. For example, the pixels 120 may be arranged in groups, for example in a stacked sensor arrangement. In some embodiments, the pixels 120 may be arranged in rows and columns. The image sensor 100 may further include control and processing circuitry 130, which may be referred to herein as control circuitry 130.

The control circuitry 130 may be coupled with row control circuitry 140 and column readout and control circuitry 150, which may be referred to herein as readout circuitry 150. The control circuitry 130 may provide timing controls for the row control circuitry 140. Based on the timing controls, the row control circuitry 140 may provide, over one or more conductive row control paths 145, corresponding row control signals such as reset, row select, charge transfer, dual conversion gain, readout, and/or any other suitable pixel control signals to each row of pixels 120.

In some embodiments, the image sensor 100 may include conductive column lines 155 coupled to each column of pixels 120 in the pixel array 110. The column lines 155 may be used for reading out signals from the pixels 120 and for supplying bias currents and/or bias voltages to the pixels 120. In some embodiments, a pixel readout operation may include selecting and controlling a pixel row in the pixel array 120 using the row control circuitry 140 and reading out, using the column lines 155, the pixel values generated by the pixels 120 in the selected row. The pixel values may be analog values, for example an analog voltage or current.

The readout circuitry 150 may control the operation, including readout, of the pixels 120 and may receive the pixel values from the column lines 155. The readout circuitry 150 may include memory circuitry for storing, whether permanently or impermanently, calibration signals such as reset level signals and reference level signals, and/or pixel signals read from the pixel array 120. The readout circuitry 150 may include amplifier circuitry, analog-to-digital conversion (ADC) circuitry, bias circuitry, control circuitry, and/or other circuitry coupled to the pixel columns of the pixel array 110.

The amplifier circuitry may amplify the pixel value readout from the pixel 120, and the ADC circuitry may convert the analog pixel values to digital pixel values. The readout circuitry 150 may provide the digital pixel values to the control circuitry 130 and/or other storage and processing circuitry of the image sensor 100 for further processing. The additional processing may include converting the digital pixel values to image data, performing HDR processing by appropriate combining multiple exposures and/or differently-gained pixel readouts, and the like.

One or more of the control circuitry 130, row control circuitry 140, and/or readout circuitry 150 may include associated storage circuitry configured to store instructions, such as firmware, software, or the like, executable by the a processing component of the respective control circuitry 130, 140, 150. The associated storage circuitry may include, for example, non-transitory computer-readable media. The stored instructions may, when executed by the respective processing component, implement one or more processes described herein, for example one or more timing diagrams for controlling one or more pixels 120, one or more process flow diagrams for adaptively performing pixel readout, and/or the like.

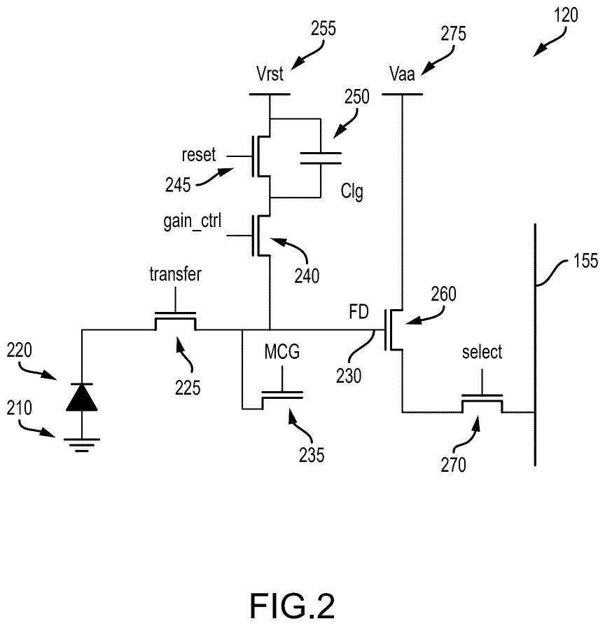

FIG. 2 is a circuit diagram of an exemplary pixel 120 according to various embodiments. The pixel 120 may include a photosensitive device such as a photodiode 220 having a first terminal coupled to a voltage terminal 210 that receives a reference voltage, for example a ground voltage. The photodiode 220 may generate charge, for example electrons, in response to receiving incident light, for example photons. The photodiode 220 may have a second terminal at which the generated charge is stored. The amount of charge generated by the photodiode 220 may depend on the exposure duration, also referred to as integration time, and on the intensity of the incident light. For example, the photodiode 220 may be exposed to a high-light level, mid-light level, low-light level, or the like. Each pixel 120 of the pixel array 110 may be exposed to different light levels in a given imaged scene.

In some embodiments, a charge transfer transistor 225 may couple the photodiode 220 to a floating diffusion region 230. The transfer transistor 225 may receive a control signal ‘transfer’ at its control terminal, for example at its gate terminal. The transfer transistor 225 may partially or fully conduct charge from the photodiode 220 to the floating diffusion region 230 when the ‘transfer’ control signal is partially or fully asserted, respectively.

In some embodiments, the pixel 120 may be configured to operate in multiple conversion gain modes, for example a low conversion gain (low gain) mode, medium conversion gain (medium gain) mode, and/or high conversion gain (high gain) mode. For example, the pixel 120 may include a charge storage structure such as a capacitor 250, for example arranged as a low gain capacitor having a capacitance C_{lg}. The capacitor 250 may have a first terminal coupled to a voltage terminal 255 and a second terminal serving as a charge storage terminal. The voltage terminal 255 may provide a voltage reference signal, such as ground or a another supply voltage ‘Vrst.’ In some embodiments, the voltage reference signal at the voltage terminal 255 may be a variable voltage signal, for example having a first voltage across a first time period and a second voltage across a second time period.

The capacitor 250 may be coupled to the floating diffusion region 230 by a gain transistor 240. The gain transistor 240 may receive a control signal ‘gain_ctrl” at its control terminal. The gain transistor 240 may conduct charge stored from the capacitor 250 to the floating diffusion region 230 or from the floating diffusion region 230 to the capacitor 250 when the ‘gain_ctrl’ control signal is asserted. When the floating diffusion region 230 is coupled with the capacitor 250 through the gain transistor 240, the charge storage capacity of the floating diffusion region 230 is effectively extended. In some embodiments, when the transfer transistor 225 and gain transistor 240 are both activated, a portion of the charge generated by the photodiode 220 may be transferred from the photodiode 220 to the capacitor 250.

In some embodiments, the pixel 120 may include a reset transistor 245 arranged to reset the pixel 120, for example to a reset voltage level. The reset transistor 245 may couple the voltage terminal 255 to the floating diffusion region 230, for example through the gain transistor 240. The reset transistor 245 may receive a control signal ‘reset’ at its control terminal, and may conduct charge to/from the voltage terminal 255 when the ‘reset’ control signal is asserted.

For example, when the reset transistor 245 and gain transistor 240 are both activated, the floating diffusion region 230 may be reset to a reset voltage level based on the supply voltage at the voltage terminal 255. In some embodiments, the reset transistor 245 may couple a terminal of the capacitor 250 to the voltage terminal 255, such that the capacitor 250 may be reset to the reset voltage level when the reset transistor 245 is activated. In some embodiments, when the reset transistor 245, gain transistor 240, and transfer transistor 225 are activated, the photodiode 220 may be reset to its pinned voltage level.

The pixel 120 may include an output. In some embodiments, the pixel 120 may include a source follower transistor 260 and a pixel or row select transistor 270 that form an output circuitry portion of the pixel 120. The source follower transistor 260 may couple a voltage terminal 275 to the select transistor 270, and the control terminal of the source follower transistor 260 may be coupled with the floating diffusion region 230. The voltage terminal 275 may provide a voltage reference signal, such as an analog-level supply voltage ‘Vaa.’ The select transistor 270 may couple the source follower transistor 260 to a column line 155 of the pixel array 110. The select transistor 270 may receive a control signal ‘select’ at its control terminal. In some embodiments, a column line 155 may be associated with one or more columns of pixels, and the ‘select’ signal may be asserted to read a pixel signal from a particular row of pixels.

When the control signal ‘select’ is asserted, a corresponding pixel output signal having a magnitude proportional to the amount of charge at the floating diffusion region 230 is passed to the column line 155 via the source follower transistor 260 and the select transistor 270. When the floating diffusion region 230 stores charge generated by the photodiode 220 in response to incident light, the corresponding pixel output signal may be referred to as an image signal or image level signal. When the floating diffusion region 230 stores a reset voltage level, the corresponding pixel output signal may be referred to as a reset signal or reset level signal. The pixel output signal may be provided to the readout circuitry 150, and then to the control circuitry 130 and/or other processing circuitry as desired.

In some embodiments, for example for HDR applications, the pixel 120 may be adapted and controlled to generate more than one set of image and reset signals for each integration time period. The multiple image and reset signals may be read out in two or more operations using varying gains. For example, the pixel 120 may be adapted and controlled to perform a low conversion gain (LCG) readout, a medium or middle conversion gain (MCG) readout, and a high conversion gain (HCG) readout. Referring still to FIG. 2, in some embodiments, the pixel 120 may include a conversion gain device such as the conversion gain device 235. The conversion gain device 235 may be referred to as a dual conversion gain or medium (or middle) conversion gain (MCG) device 235. In some embodiments, both the capacitor 250 and the MCG device 235 may be configured to be selectively connected, separately or in combination, to the floating diffusion region 230 to modify the capacitance of the floating diffusion region 230.

In some embodiment, the MCG device 235 may be a two-terminal device, for example a capacitor, a modified metal-oxide-semiconductor (MOS) transistor, or the like that provides a desired capacitance that can be selectively coupled with the floating diffusion region 230, or other device suitable to selectively modify the capacitance of the floating diffusion region 230. For example, the MCG device 235 may include a gate structure receiving a control signal ‘MCG’ and a semiconductor substrate separated by an insulator such as a gate insulator. A second terminal of the MCG device 235 may be electrically connected to the floating diffusion region 230, and may be electrically connected to the semiconductor substrate. When the MCG device 235 is activated, for example when the control signal ‘MCG’ is asserted, the MCG device 235 may provide an additional capacitance to the floating diffusion region 230.

The capacitor 250 may be configured to support an LCG mode readout operation for the pixel 120 and the MCG device 235 may be configured to support an MCG mode readout operation for the pixel 120. In some illustrative embodiments, the MCG device 235 may have a capacitance that is more than 0.25 times, more than 0.5 times, more 0.75 times, more than 1 times, more than 2 times, less than six times, less than 5 times, less than 4 times, less than 3 times, and/or less than 2 times, or in general any suitable number times the capacitance of the floating diffusion region 230. For example, the MCG device 235 may have about three to about five times the capacitance of the floating diffusion region 230. In some illustrative embodiments, the capacitor 250 may have a capacitance that is more than 3 times, more than 6 times, more than 10 times, more than 20 times, more than 30 times, more than 50 times, more than 100 times, more than 200 times, less than 150 times, less than 100 times, less than 80 times, less than 70 times, and/or less than 50 times, or in general any suitable number times the capacitance of the floating diffusion region 230. For example, the capacitor 250 may have about 70 to about 80 times the capacitance of the floating diffusion region 230. It will be recognized that any suitable capacitance values may be used, depending on design choices, desired characteristics, and/or the like.

In some embodiments, the pixel 120 may be configured to generate pixel signals, for example image signals, using various combinations of the floating diffusion region 230, MCG device 235, and capacitor 250. For example, the pixel 120 may generate pixel signals using an LCG readout such as when the capacitor 250 is connected to the floating diffusion region 230, using an MCG readout such as when the MCG device 235 is connected to the floating diffusion region 230, and using an HCG readout such as when the capacitor 250 and the MCG device 235 are both disconnected from the floating diffusion region 230.

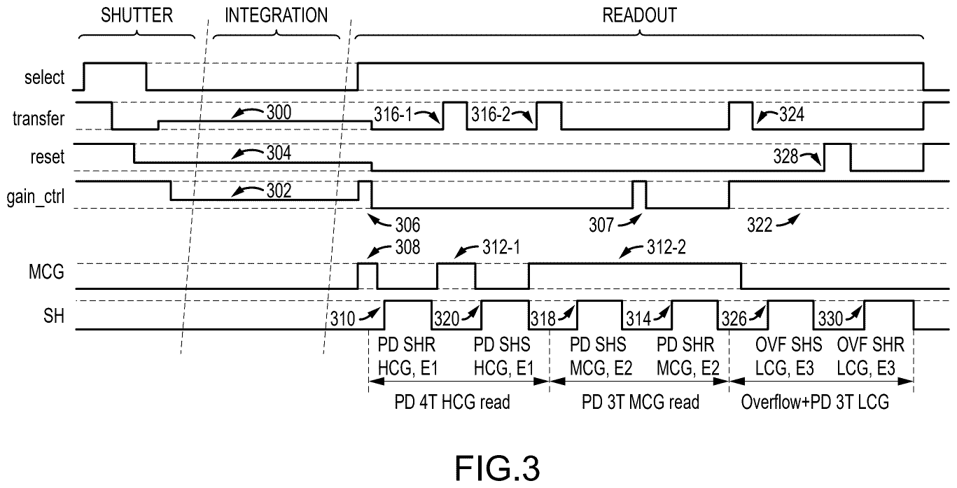

FIG. 3 is an illustrative timing diagram for operating one or more pixels 120 to perform a multi-gain readout, for example an LCG readout operation, an MCG readout operation, and an HCG readout operation. In some embodiments, the control signals described above, such as ‘select,’ ‘transfer’, ‘reset’, ‘gain_ctrl’, and ‘MCG’ may be used to control the operation of the pixel 120. For example, control circuitry such as the row control circuitry 140 and readout circuitry 150 may be configured to provide one or more of these control signals to the corresponding components of the pixel 120 and/or other circuitry such as the readout circuitry 150 via respective row control paths 145 and/or other control paths. In some embodiments, the control circuitry may provide a control signal ‘SH’ to corresponding readout circuitry 150 components such as sample-and-hold circuitry, sampling switches, and/or other related circuitry. By way of non-limiting example, a sample of the pixel signal value read out of the pixel 120 may be stored for further processing, for example analog to digital conversion, on the falling edge of the ‘SH’ signal.

The control circuitry may operate the pixel 120 during a shutter time period, and integration time period, and a readout time period. During the shutter time period, the control circuitry may fully assert control signals ‘select,’ ‘transfer,’ ‘reset,’ and ‘gain_ctrl’ to reset the components of the pixel 120, such as the floating diffusion region 230, photodiode 220, capacitor 250, MCG device 235, and/or the like, to a reset voltage level. In some embodiments, the reset voltage level may be the supply voltage ‘Vrst’ provided at the voltage terminal 255. After photodiode 40 has been reset to a reset voltage level, for example after the de-assertion (falling edge) of the ‘transfer’ signal during the shutter time period, an integration time period may begin.

During the integration time period, the pixel 120 may begin generating and accumulating charge in response to incident light. The pixel 120 may be configured to separate the generated charge into an overflow portion or overflow charge, and a remaining portion that remains stored at the photodiode 220. In some embodiments, the ‘transfer’ signal may be partially asserted 300 to set a potential barrier for the photodiode 220. The potential barrier may set or define the overflow portion of charge from the photodiode 220 and set or define the remaining portion of charge the photodiode 220. In some embodiments, the ‘gain_ctrl’ signal may also be partially asserted 302 to similarly set a potential barrier. By keeping both transistors 240 and 225 activated by the partial assertion during the integration time period, the pixel 120 allows the overflow charge in excess of a desired amounted to flow from the photodiode 220 to the floating diffusion region 230 and further to the capacitor 250.

In some embodiments, the control circuitry may also partially assert 304 the ‘reset’ signal during the integration time period. The partial assertion of the ‘reset’ signal in combination with the ‘transfer’ and ‘gain_ctrl’ signals may form an anti-blooming path for the photodiode 220. For example, charge in excess of a storage capacity of the floating diffusion region 230 and capacitor 250, which may oversaturate the pixel 120, may flow through transistors 225, 240, and 245 to voltage terminal 255. The voltage level(s) for partial assertion of each of the ‘reset,’ ‘transfer,’ and ‘gain_ctrl’ signals may be set to any suitable level(s) depending on the control signal and the desired reset, overflow, and/or anti-blooming effects.

The readout time period may occur after the integration time period. In some embodiments, the readout time period may include performing a multi-gain readout of the pixel 120, for example using LCG, MCG, and/or HCG readouts. The terms readout and readout operation may be used interchangeably herein. Further, the HCG readout may be referred to as E1, the MCG readout may be referred to as E2, and the LCG readout may be referred to as E3. In some embodiments, each of the LCG, MCG and HCG readout operations (ROs) may be configured to provide an actual pixel value according to the respective gain (low, medium, and high), indicating the actual amount of charge generated by the pixel 120 in response to the incident light. For example, the LCG, MCG, and HCG ROs may be configured to provide a pixel value that excludes charge generated by noise and/or other source.

Each of the LCG, MCG, and HCG ROs may include obtaining one or more pixel signal values, such as from a reset signal and an image signal. The readout of a reset signal may be referred to as a sample and hold of reset signal or SHR, and the readout of an image signal may be referred to as a sample and hold of image signal or SHS. Therefore, the readout time period may include performing one or more of the following readout operations: an HCG readout operation including an HCG (E1) SHR readout and an HCG (E1) SHS readout, an MCG readout operation including an MCG (E2) SHR readout and an MCG (E2) SHS readout, and/or an LCG readout operation including an LCG (E3) SHR readout and an LCG (E3) SHS readout. In some embodiments, each of the pair of E1 readouts, E2 readouts, and/or E3 readouts, for example E1 SHR and SHS, may facilitate double sampling or correlated double sampling determination of an actual pixel value for the respect gain readout, for example via subtraction of the SHR readout value from the respective SHS readout value.

At the end of the integration time period, or equivalently at the beginning of the readout time period, the control circuitry may fully assert both the ‘gain_ctrl’ 306 and ‘MCG’ 308 signals to redistribute the overflow charge between the capacitor 250, floating diffusion region 230, and MCG device 235. The charge may be redistributed based on the charge storage capacity of each respective device. The ‘select’ signal may be asserted and may remain asserted throughout the readout time period.

In some embodiments, the HCG SHR readout may then be performed. For example, after the redistribution of charge, minimal charge is left at the floating diffusion region 230 because the storage capacities of the capacitor 250 and MCG device 235 are much greater than that of the floating diffusion region 230. This redistribution of charge, with minimal charge left at the floating diffusion region 230, may effectively serve as a reset operation for the floating diffusion region 230. For example, the redistribution of charge may set the floating diffusion region 230 to (or substantially to) a reset voltage level. Subsequently, the control circuitry may assert the ‘SH’ signal 310, while control signals ‘gain_ctrl’ and ‘MCG’ are fully de-asserted. The ‘SH’ signal may activate sampling circuitry in the readout circuitry 150 to sample and store an HCG reset level signal based on the voltage level at the floating diffusion region 230.

The control circuitry may next perform an HCG image signal readout (HCG SHS). To perform the HCG SHS readout, the control circuitry may assert the ‘transfer’ signal 316-1 and the ‘MCG’ signal 312-1 to perform charge transfer operations to transfer the remaining photodiode charge to the floating diffusion region 230. Subsequently, the control circuitry may de-assert the ‘MCG’ and ‘transfer’ signals and perform the HCG readout for the image signal associated with the remaining photodiode charge by asserting the ‘SH’ signal 320. The HCG readout of the reset level and image level signals may be a correlated double sampling readout. For example, the reset level signal may be subtracted from the image level signal to obtain the actual HCG pixel signal free of reset noise. In various embodiments, the subtraction may be performed by the readout circuitry, downstream processing circuitry, or any other suitable circuitry of the image sensor 100.

In some embodiments, the MCG readout operations may be performed after the HCG readout operations. For example, the control circuitry may next perform an MCG SHS readout. To perform the MCG SHS readout, the control circuitry may assert the ‘transfer’ signal 316-2 and the ‘MCG’ signal 312-2 to ensure that any other remaining photodiode charge is transferred to the floating diffusion region 230. Subsequently, the control circuitry may keep control signal ‘MCG’ asserted and perform the MCG readout for the image signal (MCG SHS) associated with the remaining photodiode charge based on assertions 316-1 and 316-2 by asserting the ‘SH’ signal 318. The control circuitry may keep the ‘MCG’ signal asserted 312-2 throughout the MCG SHS and SHR readout operations.

The control circuitry may then perform the MCG SHR readout by first asserting the ‘gain_ctrl’ signal 307 to effectively equalize the floating diffusion region 230 to a voltage level with the capacitor 250. In some cases, this reset operation may not provide the floating diffusion region 230 with a reset level equal to the supply voltage level Vrst supplied by the voltage terminal 255 because the capacitor 250 may store overflow charge. However, this approach can provide satisfactory performance as the reset level voltage in this reset operation is a small fraction of the image level signal and has a small impact on the gain of the MCG image signal.

Subsequent to this reset operation, the control circuitry may assert the ‘SH’ signal 314 while the ‘MCG’ signal remains asserted 312-2 to perform an MCG readout for the reset level signal (MCG SHR). The MCG SHS readout may be associated with the MCG SHR readout as a double sampling readout, but the MCG SHS and MCG SHR readouts may have uncorrelated noise with respect to each other. The MCG SHR readout value may be subtracted from the MCG SHS readout value to obtain the actual MCG pixel value.

After performing the HCG and MCG readout operations for the remaining photodiode charge described above, the control circuitry may control the pixel 120 to perform a LCG SHS readout for the overflow charge in combination with the photodiode charge (OVF+PD). The overflow charge plus the photodiode charge may be the entire photodiode-generated charge. In some embodiments, the control circuitry may assert the ‘gain_ctrl’ signal 322 and may keep the ‘gain_ctrl’ signal asserted 322 during the LCG readout operations. While the ‘gain_ctrl’ signal is asserted, charge sharing may occur between the floating diffusion region 230 and the capacitor 250. The capacitor 250 may effectively increase the storage capacity of the floating diffusion region 230 many times in this low conversion gain configuration.

The control circuitry may assert the ‘transfer’ signal 324 to transfer any leftover photodiode charge to the floating diffusion region 230 and capacitor 250 connected to the floating diffusion region 230. The control circuitry may de-assert the ‘MCG’ signal. Following the transfer of any leftover photodiode charge, all of the photodiode-generated charge, including the overflow charge and the full photodiode charge, may be shared between the floating diffusion region 230 and the capacitor 250. The control circuitry may then assert the ‘SH’ signal 326 while the ‘gain_ctrl’ signal is asserted 322 to perform an LCG readout for the image level signal (LCG SHS). The LCG SHS readout may therefore be associated with the entirety of the photodiode-generated charge.

In some embodiments, a corresponding LCG reset level signal (LCG SHR) may also be read out using the low conversion gain configuration. For example, the control circuitry may assert the ‘reset’ signal 328 to reset the capacitor 250 and floating diffusion region 230, due to the still-asserted ‘gain_ctrl’ signal 322, to a reset level voltage provided by the voltage terminal 255. The control circuitry may then assert the ‘SH’ signal 330 while the ‘gain_ctrl’ signal is asserted 322 to perform an LCG SHR readout based on the reset level voltage at the combined floating diffusion region 230 and the capacitor 250. The LCG SHS readout may be associated with the LCG SHR readout as a double sampling readout, but the LCG SHS and LCG SHR readouts may have uncorrelated noise with respect to each other. The LCG SHR readout value may be subtracted from the LCG SHS readout value to obtain the actual LCG pixel value.

The timing diagram of FIG. 3 is merely illustrative, and any suitable modification may be made to the timing diagram. For example, if desired, the timing diagram of FIG. 3 may be modified such that the LCG readout operation may occur for the overflow charge, for example excluding the remaining photodiode charge, before the HCG and MCG operations for the remaining photodiode charge.

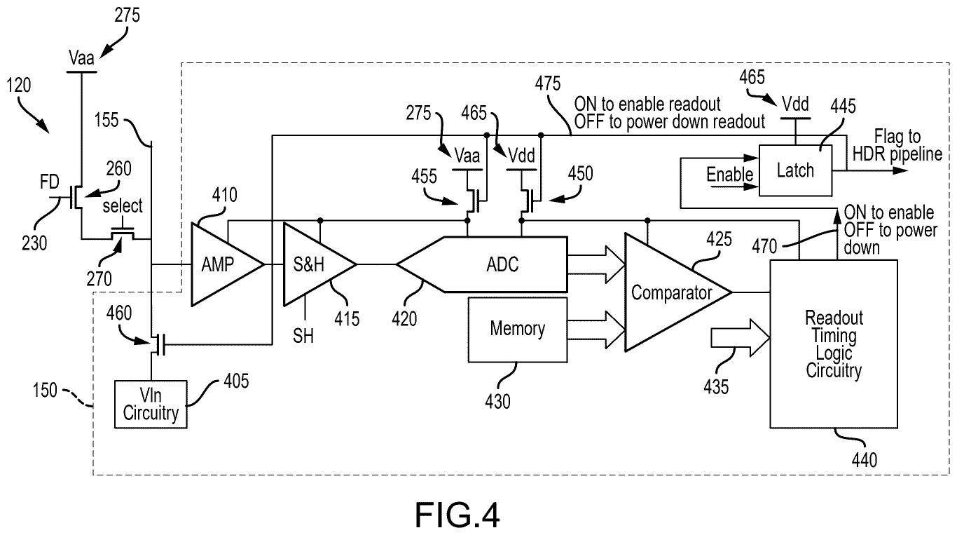

FIG. 4 is a schematic diagram showing exemplary readout circuitry 150 coupled with the output of the pixel 120, for example configured to read a pixel value based on the charge at the floating diffusion region 230 via the select transistor 270 and source follower transistor 260. For ease of reference, the remainder of the pixel 120 is not reproduced in FIG. 4. As described above, the pixel values from the pixel 120 may be supplied to the column line 155. The column line 155 may be coupled to a current source 405, which may be referred to herein as Vln circuitry 405. The current source 405 may provide a reference current for the column line and may facilitate accurate measurement of the voltage or voltage change on the column line 155 due to readout of the pixel value.

In some embodiments, image sensor 100 may use a per-column implementation of the readout circuitry 150, with each of a plurality of columns 155 having its own corresponding readout circuitry 150. In some embodiments, the image sensor 100 may be configured to use area-wise readout, for example when using image sensors having stacked substrates, and the readout circuitry 150 may be adapted to perform area-wise readouts. In some embodiments, the image sensor 100 may be configured to use per pixel readout, for example when using image sensors having stacked substrates, and the readout circuitry 150 may be configured to perform per each separate pixel readouts.

The readout circuitry 150 may include any suitable components, processors, software, and/or the like adapted to process pixel values readout from the pixel 120. In some embodiments, the readout circuitry 150 may be configured to adaptively perform and/or skip one or more reset signal or image signal readouts, for example one or more of the HCG SHR, HCG SHS, MCG SHR, MCG SHS, LCG SHR, and/or LCG SHS readouts. In some embodiments, the readout circuitry 150 may be configured to perform and/or skip the various readouts based on one or more pixel values readout from the pixel 120 and one or more thresholds. In some embodiments, one or more of the components, processors, software, functions, and/or the like described with respect to FIG. 4 may be suitably incorporated into other control circuitry, for example control circuitry 130 and/or other downstream processing circuitry.

In some embodiments, the readout circuitry 150 may include plurality of readout components, for example a column amplifier 410, sample and hold circuitry 415, and analog-to-digital conversion circuitry 420. The column amplifier 410 may provide a gain to the voltage level on the column line 155, where the voltage level is for example due to readout of a pixel value. The sample and hold circuitry 415 may be coupled to the output of the column amplifier 410, and may be configured to store a sample, also referred to as a sampled value, of the output of the column amplifier 410, for example according to an assertion of the ‘SH’ control signal. The sample may be stored in a capacitor or other suitable memory structure of the sample and hold circuitry 415. The analog-to-digital conversion circuitry 420 may be coupled with the sample and hold circuitry 415 and may convert the sampled value stored by the sample and hold circuitry 415 from an analog value to a digital value. The analog-to-digital conversion circuitry 420 may be referred to as ADC 420, and may include any suitable analog-to-digital conversion circuitry such as a ramp ADC, successive approximation register (SAR) ADC, and/or the like.

In some embodiments, the readout components of the readout circuitry 150 may further include a comparator 425 and a memory 430. The comparator 425 may include any suitable circuitry, device, or the like to compare two or more values. The comparator 425 may be suitably configured to output a comparison indication, such as a logic ‘1’ or ‘0’ or other suitable analog or digital value, if a first input of the comparator 425 is equal to, greater than, greater than or equal to, less than, less than or equal to, not equal to, etc., a second input of the comparator 425. The comparator 425 may be configured to compare the readout pixel value (or a representation thereof) to one or more thresholds and/or other values.

In some embodiments, the comparator 425 may include a digital comparator configured to compare two or more digital values. For example, the comparator 425 may be adapted to receive on one input, for example its first input, the output of the ADC 420. The comparator 425 may be further adapted to receive on another input, for example its second input, the output of the memory 430 which may include a digital value. In some other embodiments, the comparator 425 may include an analog comparator coupled to output of sample and hold circuitry 415 and configured to compare two analog values, such as the amplified pixel value prior to AD-conversion and one or more analog threshold values provided by the memory 430. Other suitable analog and mixed analog/digital implementations may be used as desired.

In some embodiments that use a digital comparator 425, the comparator 425 may advantageously use a subset of bits from entire bit width of the ADC 420 and may still provide enough granularity for an accurate comparison while reducing and/or minimizing the circuitry required for comparison. For example, the comparator 425 may be adapted to use the four most-significant bits (MSBs) of the output of the ADC 420. Other examples may suitably use a different number and/or subset of bits from the output of the ADC 420. The output of the memory 430 may be configured to match the number of bits, scaling, and/or the like based on the subset of bits used by the comparator 425.

The memory 430 may be configured to store one or more threshold values which may be usable by the comparator 425 for comparing with the pixel value read by the readout circuitry 150. For example, in embodiments in which the comparator 425 receives the AD-converted pixel value, the one or more stored threshold values (which may also be referred to as thresholds) may be digital values and may be or include the same number of bits as received by the comparator 425 from the ADC 420. The memory 430 may be any suitable storage device, such as a random-access memory, volatile memory, non-volatile memory such as one-time programmable fuses, reprogrammable memory, and/or the like. In some embodiments, the one or more thresholds may correspond to pixel values, for example reset level and/or image level values, which may be used for making decisions regarding whether to perform or skip one or more of the reset level and/or image level readouts.

In some embodiments, the memory 430 may include or otherwise store a look-up table (LUT). The LUT may be configured to store one or more threshold values corresponding to one or more pixel values. For example, the LUT may store a first threshold corresponding to a reset level (a reset-level threshold) and a second threshold corresponding to an image level (an image-level threshold). In some embodiments, the one or more thresholds may depend on one or more factors, such as the length of the integration period (as referred to as the integration time) (Tint), the temperature (Tp), and/or other desired operating condition. The LUT may be configured to store multiple values for the one or more thresholds, wherein each stored value corresponds to a particular combination of factors. For example, the LUT may store a pair of first and second thresholds for each of multiple values of integration time, temperature, and/or the like.

In some embodiments, the one or more thresholds or other values may be retrievable from the memory 430 according to the one or more factors. For example, the memory 430 may output the threshold(s) closest (or other relevant function) to the integration time, temperature, and/or other factors under which the pixel 120 is operating. The integration time may be received by the memory 430 from suitable control circuitry, for example row control circuitry 140, control circuitry 130, and/or the like. The temperature may be received and/or estimated based on one or more temperature sensors present in the image sensor 100, for example in and/or around the pixel array 110.

In some embodiments, the memory 430 may include circuitry configured to determine the threshold value(s) by approximating threshold values based on the stored threshold values and the relevant operating factors. For example, a LUT may not include threshold values for every possible combination of integration time, temperature, and/or the like. If the memory 430 receives a set of one or more factors that is not perfectly represented in the LUT, the circuitry may approximate a threshold by linear approximation, quadratic approximation, or other suitable algorithm based on two or more values in the LUT having similar operating factors. In some embodiments, the memory 430 may approximate the threshold values by using linear approximation for integration time, quadratic approximation for temperature, and/or the like.

In some embodiments, the one or more thresholds may be algorithmically generated based on one or more factors, such as integration time, temperature, and/or the like. In such embodiments, the memory 430 may be replaced and/or supplemented by appropriate threshold generation circuitry, for example hardware configured to execute a stored set of software or firmware instructions or other suitable circuitry, to perform the threshold generation.

The readout components of the readout circuitry 150 may further include a readout timing logic circuitry 440, which may also be referred to as adaptive readout control circuitry 440. The adaptive readout control circuitry 440 may be configured to receive the comparison result from the comparator 425, indicating the relationship between the output of the ADC 420 corresponding to the pixel value, and the one or more thresholds provided by the memory 430. In various embodiments, the adaptive readout control circuitry 440 may include the comparator 425 and/or memory 430. The adaptive readout control circuitry 440 may also be configured to receive one or more readout timing signals 435. The readout timing signals 435 may indicate which read is being performed, for example which of the HCG SHR, HCG SHS, MCG SHR, MCG SHS, LCG SHR, or LCG SHS readout is being or was most recently sampled by the sample and hold circuitry 415, converted by the ADC 420, compared by the comparator 425, and/or the like. In some embodiments, the readout timing signals 435 may be provided by appropriate control circuitry, such as the row control circuitry 140, control circuitry 130, and/or the like.

In some embodiments, the readout circuitry 150 may be configured to adaptively control one or more readout components of the readout circuitry 150 and/or related components to allow or skip one or more subsequent readout operations, for example based on the output of the comparator 425 and the readout timing signals 435. Exemplary details regarding the adaptive control are discussed in more detail below with respect to an adaptive readout method. The adaptive readout method may be implemented by the readout circuitry 150, and may be referred to as an adaptive readout process.

In some embodiments, the readout circuitry 150 may adaptively control the one or more components by disconnecting the one or more components from one or more supply voltages used to operate the components. For example, still referring to FIG. 4, the column amplifier 410, sample and hold circuitry 415, and/or ADC 420 may receive power from the analog-level supply voltage (Vaa), for example by electrical connection to the voltage terminal 275. The ADC 420, comparator 425, and/or adaptive readout control circuitry 440 may receive power from a digital-level supply voltage (Vdd), for example by electrical connection to a voltage terminal 465. The column line 155 may receive a current from the current source 405.

The readout circuitry 150 may include a Vaa cutoff switch 455 configured to controllably connect and disconnect the corresponding components from the voltage terminal 275. The readout circuitry 150 may include a Vdd cutoff switch 450 configured to controllably connect and disconnect the corresponding components from the voltage terminal 465. The readout circuitry 150 may include a current source cutoff switch 460 configured to controllably connect and disconnect the column line 155 from the current source 405. In some embodiments, the adaptive readout control circuitry 440 may control or otherwise affect the ‘SH’ control signal, for example by selectively disabling the control signal for readout operations that are skipped.

The adaptive readout control circuitry 440 may have an output to provide a power control signal 470 configured to control the cutoff switch(es) 450, 455, 460 according to the adaptive readout method described below. The power control signal 470 may be electrically coupled, directly or indirectly, with the cutoff switch(es). In some embodiments, the Vaa cutoff switch 455, Vdd cutoff switch 450, and current source cutoff switch 460 may include any suitable control element, for example metal-oxide-semiconductor transistors receiving the power control signal 470 at a gate input, having a source or drain terminal coupled with the voltage terminal 465, voltage terminal 275, or the current source 405 respectively, and having a drain or source terminal coupled with the voltage supply, current supply, or similar terminal of corresponding component(s).

The various states of the power control signal 470 may be suitably selected to appropriately control the various components of the readout circuitry 150, control circuitry 130, and/or the like, according to the adaptive readout method. For example, if the cutoff switch(es) 450, 455, 460 are N-type MOS (NMOS) transistors, the power control signal 470 may be asserted high to turn on the various cutoff switch(es) 450, 455, 460 so they are conductive, and may be asserted low to turn off the various cutoff switch(es) 450, 455, 460 to disconnect the respective components from the voltage and/or current supplies.

In some embodiments, the adaptive readout control circuitry 440 may be operated continuously and may receive an ungated power input, such that it is never disconnected from its respective voltage supply. For example, the adaptive readout control circuitry 440 may be directly coupled with the voltage terminal 465 without an intervening Vdd cutoff switch 450. In some such embodiments, the power control signal 470 provided by the adaptive readout control circuitry 440 may be provided directly and/or indirectly to the Vdd cutoff switch 450, Vaa cutoff switch 455, and/or current source cutoff switch 460.

The power control signal 470 may also be provided to a downstream image processing pipeline (not shown), such as an HDR pipeline. The downstream image processing pipeline may include any suitable circuitry, software, firmware, and/or the like configured to receive one or more reset level and image level readouts of the pixel 120 and to reconstruct or otherwise determine an output image value for the pixel accordingly. For example, the downstream image processing pipeline may receive the readout timing signals 435 and the output of the ADC 420 during the corresponding readout operations, and may be configured to accordingly perform HDR processing on the one or more pixel values read out of the pixel 120.

In some embodiments, the downstream image processing pipeline may be configured to use the power control signal 470 to adaptively perform processing on the one or more pixel values. For example, the downstream image processing pipeline may be configured to exclude one or more pixel values from an HDR image value calculation when the power control signal 470 indicates that a corresponding readout operation was not performed. The power control signal 470 may be referred to as an on/off flag for this purpose.

In some embodiments, the adaptive readout control circuitry 440 may also be configured to be disconnected from its respective voltage supply when one or more readout operations are skipped. For example, the adaptive readout control circuitry 440 may be coupled with the voltage terminal 465 through the Vdd cutoff switch 450, as described above. In some such embodiments, the power control signal 470 provided by the adaptive readout control circuitry 440 may be provided indirectly to the Vdd cutoff switch 450, Vaa cutoff switch 455, and/or current source cutoff switch 460.

For example, the readout circuitry 150 may include a latch 445 and the power control signal 470 may be provided to an input of the latch 445 by the adaptive readout control circuitry 440. The latch 445 may be directly coupled with and powered by the voltage terminal 465. The latch 445 may provide a latched or otherwise stored version of the power control signal 470, for example on its output, to the Vdd cutoff switch 450, Vaa cutoff switch 455, and/or current source cutoff switch 460. For example, if the adaptive readout control circuitry 440 is powered down (disconnected from a respective voltage supply) due to the execution of its adaptive readout process, the state of the latched power control signal 475 may be maintained by the latch 445 and may continue to disconnect the respective components from the respective power supplies 465, 275 even while the adaptive readout control circuitry 440 is powered off. In some such embodiments, the on/off flag may be provided by the latch 445 to the downstream image processing pipeline.

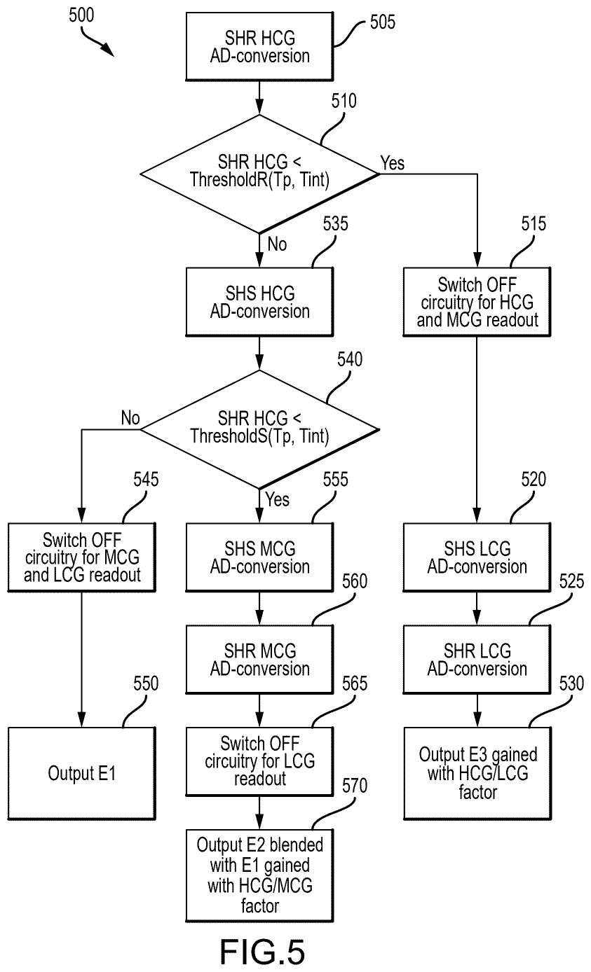

In embodiments, the latch 445 may include an input configured to receive an ‘Enable’ signal. When the ‘Enable’ signal is asserted, the latch 445 may be configured to force on the cutoff switch(es) 450, 455, 460 to enable readout by appropriate controlling the latched power control signal 475, for example overriding the state of the power control signal 470. In some embodiments, the ‘Enable’ signal may also be latchable by the latch 445, for example able to maintain its state if the ‘Enable’ signal is de-asserted. In some embodiments, the ‘Enable’ signal may be pulse asserted at the beginning of each pixel readout cycle, for example at the end of an integration period. In some embodiments, the ‘Enable’ signal may be pulse asserted in the case that only the LCG readout is required, for example after analysis of earlier readout operations as described with respect to FIG. 5 below.

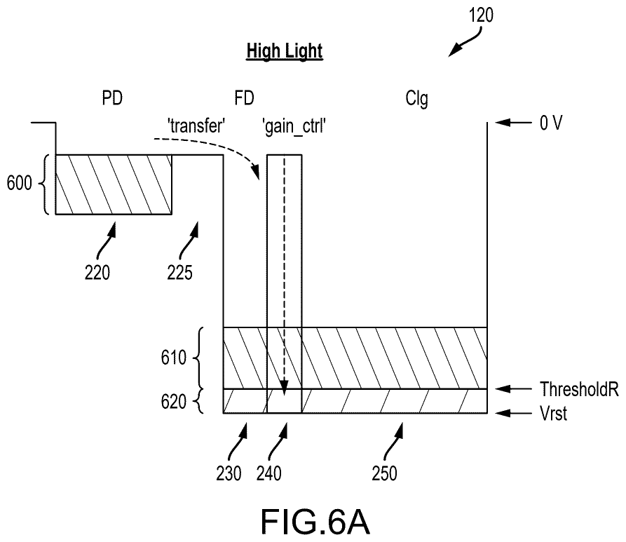

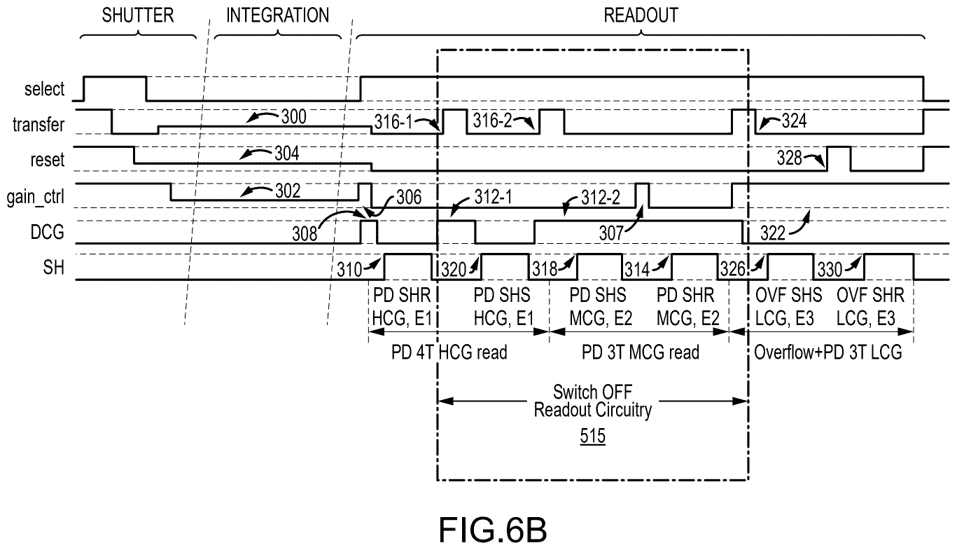

FIG. 5 is a flowchart illustrating an exemplary adaptive readout method 500 for adaptively performing the various readout operations described with respect to FIG. 3. The adaptive readout method 500 may be performed by the readout circuitry 150, for example implemented in the adaptive readout control circuitry 440 and/or performed by related circuitry such as the comparator 425, memory 430, and/or the like. Adaptively performing the various readout operations may include various combinations of selectively performing and not performing the HCG SHR, HCG SHS, MCG SHR, MCG SHS, LCG SHR, and/or LCG SHS readout operations. FIGS. 6B, 7B, and 8B representatively illustrate various combinations of readout operations that are and are not performed from the timing diagram of FIG. 3, according to the adaptive readout method 500. Not performing a readout operation may be referred to as disabling the readout operation.

In some embodiments, disabling or not performing one or more of the readout operations (RO) may include disconnecting respective circuitry of the readout circuitry 150, control circuitry 130, and/or the like from one or more voltage and/or current supplies to reduce power usage of the image sensor 100. In some embodiments, not performing one or more of the readout operations may include the adaptive readout control circuitry 440 controlling the disconnection of the respective circuitry. In some embodiments, the adaptive performance of the readout operations may be determined according to one or more reset level and/or image level readouts performed according to FIG. 3. The adaptive readout method 500 will be described with respect to the state of the various pixel 120 components under different light conditions, for example as illustrated in FIGS. 6A, 7A, and 8A.

FIGS. 6A, 7A, and 8A are charge-based potential diagram representations of various pixel 120 elements during various readout operations where the lower extents of the illustrations represent the reset voltage level, for example provided by the voltage terminal 255, and the upper extents represent a maximum amount of charge, for example causing the pixel 120 element to have a voltage potential of about 0 V. The various pixel 120 transistors, for example transfer transistor 225 and gain transistor 240, appear as potential barriers to the movement of the charge within the pixel 120. The various storage nodes of the pixel 120, for example the photodiode 220, floating diffusion region 230, and capacitor 250, appear as “buckets” that can be filled with the charge. Charge may flow from one storage node to another depending, for example, on the amount of charge, size of the storage node, and potential of the potential barrier(s).

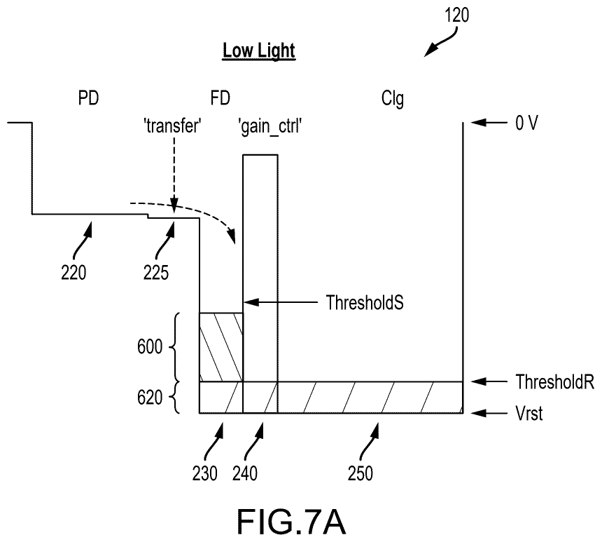

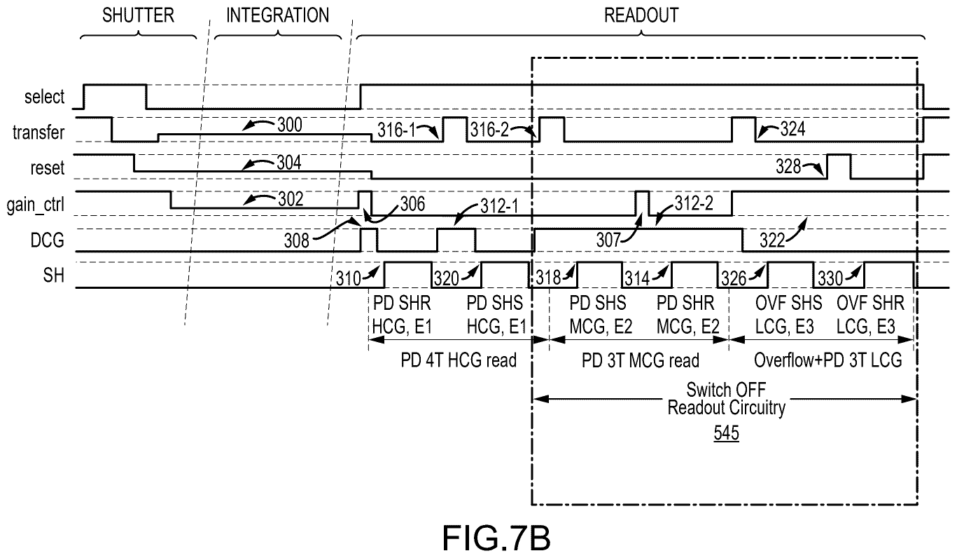

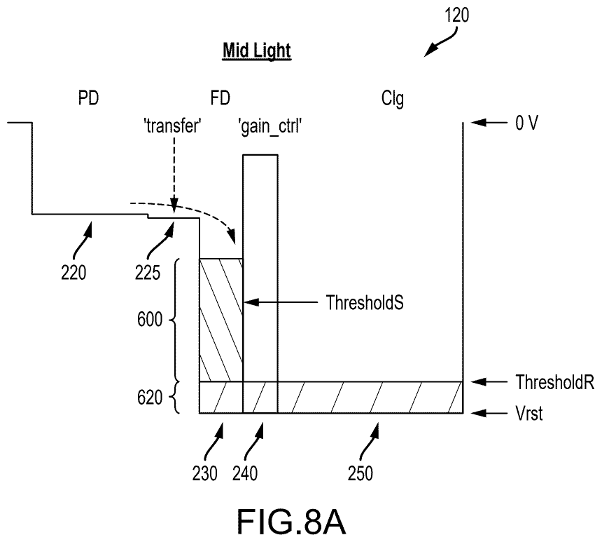

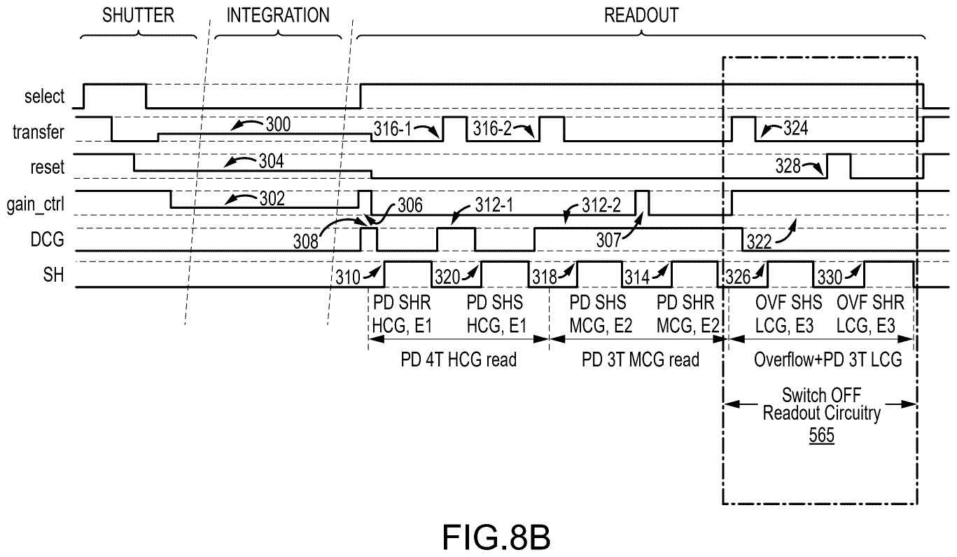

More specifically, FIG. 6A representatively illustrates a state of noise and generated charge after the HCG SHR readout operation in response to a pixel capturing a high light part of an image scene, FIG. 7A representatively illustrates a state of noise and generated charge after the HCG SHS readout operation in response to a pixel capturing a low light part of an image scene, and FIG. 8A representatively illustrates a state of noise and generated charge after the HCG SHS readout operation in response to a pixel capturing a medium (mid) light part of an image scene.

Referring FIG. 6A, as described above, prior to performing the HCG SHR readout at step 505, the pixel 120 components were reset to a reset voltage level during the shutter time period. By way of non-limiting example, a reset voltage level Vrst from the voltage terminal 255 may be about 2.8 V or any other suitable voltage level. As the photodiode 220 generates charge during the following integration period in response to incident photons, the floating diffusion region 230 and/or the capacitor 250 may accumulate charge in the form of noise 620.

The noise 620, also referred to as parasitic charge, may for example be caused by dark current or other undesired effects. The amount of noise 620 accumulated may correspond to the temperature of the pixel 120 and/or respective components (represented by variable Tp), the length of the integration time period (also referred to at the integration time and represented by the variable Tint), and/or other factors. In some embodiments, the generated and accumulated charge may reduce the potential of the photodiode 220, floating diffusion region 230, capacitor 250, and/or the like from the reset value Vrst toward a common voltage reference such as a ground, for example 0 V.

As described above, the gain transistor 240 and transfer transistor 225 may be partially activated by the partial assertion of the ‘gain_ctrl’ and ‘transfer’ signals during the integration time period, allowing excess charge generated by the photodiode 220 due to a high light condition to overflow from the photodiode 220 to the floating diffusion region 230 and further to the capacitor 250. The charge that overflowed from the photodiode 220 results in an overflow charge portion 610, and the remainder of the generated charge is located at the photodiode 220 as the remaining charge portion 600. In some embodiments, as described above, the ‘gain_ctrl’ signal may be fully asserted 306 to redistribute the overflow charge at the end of the integration period, which is illustrated by the downward arrow under ‘gain_ctrl’ in FIG. 6A. Accordingly, in some embodiments during a high light condition, the total charge at the floating diffusion region 230 may include a combination of both the overflow charge portion 610 and noise 620.

Referring again to FIG. 5, at step 505, after the integration period the control circuitry may perform the HCG reset level readout (HCG SHR) as described above with respect to FIG. 3, which may for example include performing an analog-to-digital (AD) conversion of the reset level readout from the pixel 120. In some embodiments, the AD conversion may be performed by the readout circuitry 150, for example the ADC 420. In other embodiments, the threshold check process steps described below with respect to the adaptive readout method 500 may be suitably performed based on the analog pixel value without or prior to an AD conversion.

At step 510, the readout circuitry 150 may compare the HCG SHR reset level signal to a reset-level threshold, illustrated as ThresholdR in FIG. 5. In some embodiments, the reset-level threshold may be selected such that it exceeds the range of noise 620 expected at the floating diffusion region 230 based on the operating conditions of the image sensor 100. For example, the reset-level threshold may be predetermined and/or may be dynamically set based on one or more parameters such as the temperature Tp, integration time Tint, and/or the like. In some embodiments, the comparison may be performed by the comparator 425 based on the received value from the ADC 420 and a respective threshold value from the memory 430. Threshold values may be retrieved from the memory 430 according to one or more operating conditions, such as Tp, Tint, and/or the like, as described above.

The thresholds are described herein with respect to the voltage and charge levels at the floating diffusion region 230 as illustrated in FIGS. 6A, 7A, and 8A. However, it will be understood that the thresholds may be selected according to the corresponding value of the pixel readout on the column line 155 or as modified by the column amplifier 410, sample and hold circuitry 415, ADC 420, and/or the like. For example, the value of the pixel readout on the column line 155 may be amplified by the column amplifier 410 and converted to a digital representation by the ADC 420, and the corresponding thresholds (reset level, image level) may be digital values at an amplified level compared to that found on the floating diffusion region 230.

In some embodiments, for example where the reset voltage level (e.g., 2.8 V) is greater than the image level due to the accumulated and/or generated charge as illustrated in FIG. 6A, the reset-level threshold may be selected to correspond to a voltage level on the floating diffusion region 230 that is less than or equal to the reset voltage level minus the expected noise 620. It will also be recognized that the adaptive readout method 500 may be suitably adapted to pixel circuits operating with a lower reset voltage level and a higher image and/or reset voltage level, for example by selecting different thresholds, changing the sign of the threshold comparisons, and/or the like.

For example, with no overflow charge portion 610 present on the floating diffusion region 230, the voltage level of the floating diffusion region 230 may be expected to be equal to or greater than the reset-level threshold. If noise is present at the floating diffusion region 230 without the overflow charge portion 610, then the voltage level of the floating diffusion region 230 may be between the reset-level threshold and the reset voltage level. If some overflow charge portion 610 is present on the floating diffusion region 230, then the voltage level of the floating diffusion region 230 may be less than the reset-level threshold. In such an example, the floating diffusion region 230 may have a voltage level equal to the reset voltage level minus the noise 620 minus the overflow charge portion 610.

If the comparison at step 510 indicates that the HCG SHR reset level signal is less than the reset-level threshold, then it may be assumed that this particular pixel 120 was subjected to a high light condition causing charge to overflow from the photodiode 220 to the floating diffusion region 230 and accordingly lowering the voltage level at the floating diffusion region 230 further than what would be caused solely by noise 620. In such a case, the HCG (low light) and MCG (medium light) readout operations may contribute an insignificant or no amount to a final pixel value to be determined by the downstream processing circuitry for this particular pixel 120, and the respective readouts may be skipped (not performed) by the readout circuitry 150.

Referring to FIGS. 5 and 6B, if the HCG SHR reset level signal is determined to be less than the reset-level threshold ThresholdR at step 510, then the readout circuitry 150 may, at step 515, responsively turn off one or more respective components of the readout circuitry 150 during the subsequent HCG SHS, MCG SHR, and MCG SHS readout operations. For example, in some embodiments, at step 515, the adaptive readout control circuitry 440 may control the power control signal 470 to turn off the Vdd cutoff switch 450, Vaa cutoff switch 455, and/or current source cutoff switch 460. The readout circuitry 150 may, at step 515, disconnect the adaptive readout control circuitry 440 from its respective voltage supply.

At the end of step 515, the readout circuitry 150 may turn on the respective components to allow the subsequent LCG SHS and LCG SHR readout operations. For example, the adaptive readout control circuitry 440 or associated circuitry may control the power control signal 470 to turn on the Vdd cutoff switch 450, Vaa cutoff switch 455, and/or current source cutoff switch 460 to enable the respective readout circuitry 150 components. In some embodiments, the latch 445 may be reset using the ‘Enable’ signal or otherwise controlled to provide a latched power control signal 475 that enables the respective components.

At step 520, the readout circuitry 150 may perform the LCG SHS readout operation, and at step 525 may perform the LCG SHR readout operation, for example as described above with respect to FIG. 3. For example, steps 520 and 525 may include amplifying the values on the column line 155 using the column amplifier 410, sampling the respective value using the sample and hold circuitry 415, and performing AD conversions using the ADC 420.

At step 530, the downstream processing circuitry may determine and output the final pixel value according to the LCG (E3) readouts of steps 520 and 525, without consideration of the HCG SHS readout operation at step 505. More generally, the downstream processing circuitry may be configured to account for the lack of various combinations of HCG, MCG, and/or LCG readout values, as indicated by the power control signal 470, when determining the final pixel value for the pixel 120.

In some embodiments, the output of the ADC 420 for the LCG SHS 520 and LCG SHR 525 readout operations may be provided to the downstream processing circuitry for final pixel value determination at step 530. For example, the downstream processing circuitry may determine the final pixel value by determining a pixel value based on the LCG readouts 520, 525 and gaining, amplifying, or otherwise multiplying the determined pixel value by an HCG to LCG factor. The HCG to LCG factor may be based on the ratio of the capacitance of the capacitor 250 to the capacitance of the floating diffusion region 230. For example, if the capacitance of the capacitor 250 is about 70 times that of the floating diffusion region 230, then the gain used for the E3 readout may be about 70.

Accordingly, a pixel 120 that captures a high light part of an image scene may require only three AD conversions and the readout circuitry 150 may be switched off for the remainder of the HCG RO and for the MCG RO, for example from the end of the HCG SHR readout to the beginning of the LCG SHS readout. Consequently, through steps 505, 510, 515, 520, 525, and 530, the readout circuitry 150 only performs the HCG SHR, LCG SHR, and LCG SHS readout operations in a high light condition, achieving an approximate 50% reduction in readout power consumption compared to performing a full set of HCG, MCG, and LCG row readout operations.

Returning to step 510, if the comparison indicates that the HCG SHR reset level signal is not less than the reset-level threshold, then it may be assumed that this particular pixel 120 was not subjected to a high light condition because the voltage level at the floating diffusion region 230 is not lower than what would be caused solely by noise 620. Such a comparison result at step 510 indicates that no charge overflowed from the photodiode 220 to the floating diffusion region 230, and consequently that the pixel 120 was not subjected to a high light condition. The adaptive readout method 500 may then determine to skip the LCG readout operations and perform one or more of the HCG and MCG readout operations based on further determinations of whether the pixel 120 was subjected to a low light or medium light condition.

If the comparison at step 510 determines that the HCG SHR reset level signal is not less than the reset-level threshold, then at step 535 the adaptive readout method 500, for example executed by the adaptive readout control circuitry 440, may cause or otherwise allow the readout circuitry 150 to perform the HCG SHS readout operation, for example as described above with respect to FIG. 3. In some embodiments, the HCG SHS readout operation may include performing an AD conversion of the image level readout from the pixel 120, as well as the other readout operations such as amplifying, sampling, and/or the like.

At step 540, the readout circuitry 150 may compare the HCG SHS image level signal to a image-level threshold, illustrated as ThresholdS in FIG. 5. Referring briefly to FIG. 7A, in some embodiments, the image-level threshold may be selected such that it exceeds the range of noise 620 expected at the floating diffusion region 230 based on the operating conditions of the image sensor 100 combined with an amount of generated charge transferred from the photodiode 220 to the floating diffusion region 230 via assertion of the ‘transfer’ control signal during the HCG SHS readout. The image-level threshold may be predetermined and/or may be dynamically set based on the operating conditions, such as Tp, Tint, and/or the like. In some embodiments, the comparison may be performed by the comparator 425 based on the received value from the ADC 420 and a respective threshold value from the memory 430. Threshold values may be retrieved from the memory 430 according to one or more operating conditions, such as Tp, Tint, and/or the like, as described above.

For example, in low or medium light conditions, the remaining charge portion 600 at the photodiode 220 may include the entirety of the charge generated by the photodiode 220, with no or substantially no overflow charge portion 610 being generated. The image-level threshold may be based on an amount of generated charge at the photodiode 220 that corresponds to the transition between a low light condition and a medium light condition. In some embodiments, the image-level threshold may be selected to equal the expected noise 620, based on the operating conditions (Tp, Tint, etc.), plus the maximum amount of generated charge at the photodiode 220 that can be generated in response to a low light condition. For example, the full charge capacity of the photodiode 220 may only be reached in a medium light condition.

Returning to FIG. 5, if the comparison at step 540 indicates that the HCG SHR reset level signal is not less than the image-level threshold ThresholdS, then it may be assumed that this particular pixel 120 was subjected to a low light condition under which the photodiode 220 was not able to generate sufficient charge to, in combination with the noise 620, reduce the initial reset level of the floating diffusion region 230 to below the image-level threshold. In such a case, the HCG (low light) readout operations may be able to sufficiently resolve a final pixel value, and the MCG (medium light) and LCG (high light) readout operations may contribute an insignificant or no amount to the final pixel value. Accordingly, the respective MCG and LCG readouts may be skipped (not performed) by the readout circuitry 150.

Referring to FIGS. 5 and 7B, if the HCG SHS image level signal is determined to not be less than the image-level threshold ThresholdS at step 540, then the readout circuitry 150 may, at step 545, responsively turn off one or more respective components of the readout circuitry 150 during the subsequent MCG SHS, MCG SHR, LCG SHS, and LCG SHR readout operations. For example, in some embodiments, at step 545, the adaptive readout control circuitry 440 may control the power control signal 470 to turn off the Vdd cutoff switch 450, Vaa cutoff switch 455, and/or current source cutoff switch 460 during the corresponding readout operations.

The readout circuitry 150 may, at step 545, also disconnect the adaptive readout control circuitry 440 from its respective voltage supply during the respective subsequent readout operations. In some embodiments, at the end of step 545, the adaptive readout control circuitry 440 or associated circuitry may control the power control signal 470 to turn on the Vdd cutoff switch 450, Vaa cutoff switch 455, and/or current source cutoff switch 460 to enable the respective readout circuitry 150 components for the next set of HCG, MCG, and LCG readouts after the next integration period. In some embodiments, at the end of step 545, the adaptive readout control circuitry 440 or associated circuitry may control the ‘Enable’ signal for the same purpose.

At step 550, the downstream processing circuitry may determine and output the final pixel value for the pixel 120 according to the HCG (E1) readouts of steps 505 and 535. In some embodiments, the output of the ADC 420 for the HCG SHR 505 and HCG SHS 535 readout operations may be provided to the downstream processing circuitry for final pixel value determination at step 550. In some embodiments, the downstream processing circuitry may output the final pixel value without any additional gain or amplification.

Accordingly, a pixel 120 that captures a low light part of an image scene may require only two AD conversions and the readout circuitry 150 may be switched off for the remainder of the row readout operations for MCG and LCG. Consequently, through steps 505, 510, 535, 540, 545, and 550, the readout circuitry 150 only performs the HCG SHR and HCG SHS readout operations in a low light condition, achieving an approximate 66% reduction in readout power consumption compared to performing a full set of HCG, MCG, and LCG row readout operations.

Returning to step 540, if the comparison indicates that the HCG SHS image level signal is less than the image-level threshold ThresholdS, then it may be assumed that this particular pixel 120 was subjected to a medium light condition under which the photodiode 220 was able to generate sufficient charge to, in combination with the noise 620, reduce the initial reset level of the floating diffusion region 230 to below the image-level threshold. In such a case, the HCG (low light) and MCG (medium light) readout operations may be able to sufficiently resolve a final pixel value, and the LCG (high light) readout operation may contribute an insignificant or no amount to the final pixel value. Accordingly, the respective LCG readouts may be skipped (not performed) by the readout circuitry 150.

Referring to FIGS. 5 and 8B, if the HCG SHS image level signal is determined to be less than the image-level threshold ThresholdS at step 540, then the readout circuitry 150 may, at step 555, perform the MCG SHS readout operation, and at step 560 may perform the MCG SHR readout operation, for example as described above with respect to FIG. 3. For example, steps 555 and 560 may include amplifying the values on the column line 155 using the column amplifier 410, sampling the respective value using the sample and hold circuitry 415, and performing AD conversions using the ADC 420.

At step 565, after having performed the HCG and MCG readout operations, the readout circuitry 150 may turn off one or more respective components of the readout circuitry 150 during the subsequent LCG SHS and LCG SHR readout operations. For example, in some embodiments, at step 565, the adaptive readout control circuitry 440 may control the power control signal 470 to turn off the Vdd cutoff switch 450, Vaa cutoff switch 455, and/or current source cutoff switch 460. The readout circuitry 150 may, at step 565, disconnect the adaptive readout control circuitry 440 from its respective voltage supply.

In some embodiments, at the end of step 565, the adaptive readout control circuitry 440 or associated circuitry may control the power control signal 470 to turn on the Vdd cutoff switch 450, Vaa cutoff switch 455, and/or current source cutoff switch 460 to enable the respective readout circuitry 150 components for the next set of HCG, MCG, and LCG readouts after the next integration period. In some embodiments, at the end of step 565, the adaptive readout control circuitry 440 or associated circuitry may control the ‘Enable’ signal for the same purpose.

In some embodiments, the output of the ADC 420 for the HCG SHR 505, HCG SHS 535, MCG SHS 555, and MCG SHR 560 readout operations may be provided to the downstream processing circuitry for final pixel value determination at step 570. For example, the downstream processing circuitry may determine and output the final pixel value for the pixel 120 based on the HCG (E1) readout operations of steps 505 and 535 and the MCG (E2) readout operations of steps 555 and 560.

In some embodiments, the downstream processing circuitry may amplify the indicated pixel value from the MCG (E2) readout operations by multiplying it by an HCG to MCG factor. The HCG to MCG factor may be based on the ratio of the capacitance of the MCG device 235 to the capacitance of the floating diffusion region 230. For example, if the capacitance of the MCG device 235 is about 5 times that of the floating diffusion region 230, then the gain used for the E2 readout may be about 5.

The downstream processing circuitry may determine the final pixel value based on a blend of the amplified MCG (E2) readout value and the non-amplified indicated pixel value from the HCG (E1) readout operations. In some embodiments, the blend of the E1 and (amplified) E2 readout values may be based on the relative strength of the indicated MCG and LCG values. For example, as the light level to which the pixel 120 is exposed increases from the transition region between the low and medium light levels to a level just before overflow (e.g., at the photodiode's 220 full well capacity), the HCG SHS readout value will decrease further from the image-level threshold ThresholdS. The HCG SHS readout value and/or corresponding values determined through the readout circuitry 150 may therefore indicate the relative strength of the light to which the pixel 120 was exposed and therefore the relative weights of the amplified E2 readout and non-amplified E1 readout in the blend of the final pixel value. For example, as the HCG SHS readout value decreases further from the image-level threshold, the downstream processing circuitry may increase the relative weight of the indicated value from the MCG readouts compared to the HCG readouts in the final pixel value blend.

Accordingly, a pixel 120 that captures a medium light part of an image scene may require only four AD conversions and the readout circuitry 150 may be switched off for the remainder of the row readout operations for LCG. Consequently, through steps 505, 510, 535, 540, 555, 560, 565, and 570, the readout circuitry 150 only performs the HCG SHR, HCG SHS, MCG SHS, and MCG SHR readout operations in a medium light condition, achieving an approximate 33% reduction in readout power consumption compared to performing a full set of HCG, MCG, and LCG row readout operations.

The adaptive readout method 500 may be suitably adapted to pixels, readout circuitry, image sensors, and/or the like in which the readout operations are arranged in a different ordering than described herein. For example, the flow chart of FIG. 5 may be rearranged for various orderings of the E1, E2, and E3 readout operations.

Accordingly, the adaptive readout method 500 provide a logical analysis of a first SHR pixel output to make a branching decision for shutdown of the readout circuitry for the duration of mid gain readout with wake-up and continuation for the low gain readout, a further logical analysis of a first SHS pixel output to make branching decision for shutdown of the readout circuitry for the duration of mid and low gain readout or continuation of the mid gain readout and shutdown of the readout circuitry for the duration of low gain readout.

Various embodiments therefore provide systems, devices, and methods that can adaptively perform and/or skip one or more multi-gain readout operations based on the values provided by a pixel and depending on the amount of incident light to which the pixel is exposed. The image sensor 100 may include a readout circuitry 150 having an adaptive readout control circuitry 440 configured to compare a pixel value to a threshold and responsively disabling one or more subsequent readout operations. Various embodiments may include adapting a reset threshold and an image threshold based on the sensor temperature, integration period, and/or the like.

Advantageously, an image sensor according to various embodiments described herein may perform only or substantially only those readout operations required, under the given lighting conditions, to determine an accurate final pixel value while minimizing the amount of power used for the readout operations. Various embodiments may include a 33% to a 66% readout power reduction depending on the incident light levels. The power savings may be achieved with minimal impact to manufacturing cost. In contrast, prior methods include performing all readout operations regardless of light levels.

The various components and functions shown and described with respect to the process flows and image sensor may be distributed amongst the various components of the image sensor 100 and/or external systems in any manner, and different embodiments may organize the processing of various features and information in any number of different ways. Several of the various features and systems described herein may be implemented in software and/or firmware that resides in non-transitory data storage for execution by one or more processors to perform the various (automated) processes described herein. For example, the adaptive readout control circuitry 440 and/or adaptive readout method 500 may be implemented using a processor, transistor logic, a field programmable gate array (FPGA), state machine, and/or the like.

The arrangement of the pixel 120 herein is merely illustrative. In general, any desired pixel circuitry may be used with the readout circuitry shown in connection with FIG. 4. The pixel circuitry may include an anti-blooming transistor, one or more multi-gain transistors and/or storage nodes, and the like. The readout circuitry of FIG. 4 may be used in an image sensor that operates with a rolling shutter (in which each row of pixels sequentially captures an image) or a global shutter (in which every pixel in the image sensor simultaneously captures an image).

It will be recognized that various circuitry described herein may alternatively or additionally be implemented as computer instructions (software, firmware, or the like) configured to cause a processor to perform the functions of the described circuitry. It will also be recognized that computer instructions and/or automated processes described herein may alternatively or additionally be implemented as hardware circuitry operable to perform the functions of the described computer instructions.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A method for multi-gain readout of a pixel of an image sensor, comprising:
obtaining a high conversion gain (HCG) reset value from the pixel;
comparing the HCG reset value to a first threshold;
in response to the HCG reset value being less than the first threshold, disabling an HCG image value readout operation (RO) and a medium conversion gain (MCG) RO; and
in response to the HCG reset value being greater than or equal to the first threshold:
obtaining an HCG image value from the pixel;
comparing the HCG image value to a second threshold;
in response to the HCG image value being less than the second threshold, disabling a low conversion gain (LCG) RO; and
in response to the HCG image value being greater than or equal to the second threshold, disabling the MCG RO and the LCG RO.

2. The method of claim 1, wherein:
disabling the MCG RO comprises disabling an MCG image value RO and an MCG reset value RO; and
disabling the LCG RO comprises disabling an LCG image value RO and an LCG reset value RO.

3. The method of claim 2, wherein the image sensor comprises a readout circuitry comprising an analog-to-digital converter, a sample-and-hold circuitry, and an amplifier, and wherein:
disabling a readout operation comprises disconnecting the analog-to-digital converter, the sample-and-hold circuitry, or the amplifier from a supply voltage during the readout operation.

4. The method of claim 1, wherein the image sensor comprises a readout circuitry comprising a comparator, and wherein:
the HCG reset value and the HCG image value are obtained from the pixel using the readout circuitry;
the HCG reset value is compared to the first threshold using the comparator; and
the HCG image value is compared to the second threshold using the comparator.

5. The method of claim 4, wherein the readout circuitry further comprises a memory coupled with the comparator, and wherein:
comparing the HCG reset value to the first threshold comprises obtaining the first threshold from the memory; and
comparing the HCG image value to the second threshold comprises obtaining the second threshold from the memory.

6. The method of claim 1, further comprising:
selecting the first threshold based on a temperature of the image sensor and a length of an integration period; and
selecting the second threshold based on the temperature of the image sensor and the length of the integration period.

7. The method of claim 1, further comprising:
providing, in response to the HCG reset value being less than the first threshold, a final pixel value based on the LCG RO;
providing, in response to the HCG image value being less than the second threshold, the final pixel value based on the HCG reset value, HCG image value, and the MCG RO; and
providing, in response to the HCG image value being greater than or equal to the second threshold, the final pixel value based on the HCG reset value and the HCG image value.

8. An image sensor, comprising:
a pixel having an output and configured to provide, on the output, a pixel value; and
a readout circuitry coupled with the output of the pixel, wherein the readout circuitry comprises:
a memory configured to provide a first threshold; and
a plurality of readout components, wherein the plurality of readout components comprises:
a sample and hold circuitry configured to store a sampled value corresponding to the pixel value;
a comparator coupled with the memory and the sample and hold circuitry and configured to compare the sampled value to the first threshold and responsively output a first comparison result; and
an adaptive readout control circuitry coupled with the comparator and configured to controllably disconnect at least one of the plurality of readout components from a supply voltage in response to the comparison result.

9. The image sensor of claim 8, wherein the plurality of readout components further comprises:
an amplifier coupled with the output of the pixel and configured to amplify the pixel value, wherein the sample and hold circuitry is coupled with an output of the amplifier; and
an analog-to-digital converter (ADC) coupled with the sample and hold circuitry and configured to convert the sampled value to a digital value, wherein:
the comparator is coupled with an output of the ADC; and
comparing the sampled value to the first threshold comprises comparing the digital value to the first threshold.

10. The image sensor of claim 9, wherein:
the image sensor comprises a column line and a current source;
the column line is coupled with a current source, the amplifier, and the output of the pixel; and
the adaptive readout control circuitry is further configured to controllably disconnect the column line from the current source in response to the comparison result.

11. The image sensor of claim 8, wherein:
the pixel comprises an overflow pixel configured to provide a plurality of pixel values in response to a plurality of corresponding readout operations (RO), wherein the plurality of pixel values comprises a high conversion gain (HCG) reset value, an HCG image value, a medium conversion gain (MCG) reset value, an MCG image value, a low conversion (LCG) reset value, and an LCG image value;
the memory is configured to provide a second threshold to the comparator, wherein:
the first threshold corresponds to an HCG reset value RO;
the second threshold corresponds an HCG image value RO; and
the comparator is configured to compare the sampled value to the second threshold and responsively output a second comparison result; and
the adaptive readout control circuitry is configured to disconnect the at least one of the readout components from the supply voltage during at least one of the readout operations based on the first comparison result or the second comparison result.

12. The image sensor of claim 11, wherein the adaptive readout control circuitry is configured to:
disconnect, in response to the first comparison result indicating that the HCG reset value is less than the first threshold, the at least one of the readout components from the supply voltage during an HCG image value RO, an MCG image value RO, and an MCG reset value RO;
disconnect, in response to the first comparison result indicating that the HCG reset value is greater than or equal to the first threshold and the second comparison result indicating that the HCG image value is less than the second threshold, the at least one of the readout components from the supply voltage during an LCG image value RO and an LCG reset value RO; and
disconnect, in response to the first comparison result indicating that the HCG reset value is greater than or equal to the first threshold and the second comparison result indicating that the HCG image value is greater than or equal to the second threshold, the at least one of the readout components from the supply voltage during the MCG image value RO, the MCG reset value RO, the LCG image value RO, and the LCG reset value RO.

13. The image sensor of claim 12, wherein the image sensor is configured to provide:
a final pixel value based on the LCG image value and the LCG reset value in response to the first comparison result indicating that the HCG reset value is less than the first threshold;
the final pixel value based on the HCG reset value, the HCG image value, the MCG image value, and the MCG reset value in response to the first comparison result indicating that the HCG reset value is greater than or equal to the first threshold and the second comparison result indicating that the HCG image value is less than the second threshold; and
the final pixel value based on the HCG reset value and the HCG image value in response to the first comparison result indicating that the HCG reset value is greater than or equal to the first threshold and the second comparison result indicating that the HCG image value is greater than or equal to the second threshold.

14. The image sensor of claim 11, wherein the memory is configured to provide the first threshold and the second threshold based on a temperature of the image sensor or a length of an integration period for the pixel.

15. The image sensor of claim 8, wherein:
the image sensor comprises a voltage terminal configured to provide the supply voltage; and
the readout circuitry comprises a cutoff switch coupled between the voltage terminal and the at least one of the plurality of readout components, wherein controllably disconnecting the at least one of the plurality of readout components from the supply voltage comprises controlling the cutoff switch.

16. An adaptive readout control circuitry configured to couple with a readout circuitry of an image sensor, comprising:
a first input configured to receive, from the readout circuitry, a digital value corresponding to a pixel value;
a second input configured to receive a first threshold; and
an output configured to couple with the readout circuitry, wherein the adaptive readout control circuitry is configured to:
compare the digital value to the first threshold; and
controllably disable, via the output and based on the comparison, the readout circuitry during one or more pixel readout operations (RO).

17. The adaptive readout control circuitry of claim 16, wherein:
the second input is further configured to receive a second threshold, wherein the first threshold corresponds to a reset value and the second threshold corresponds to an image value; and
the adaptive readout control circuitry is configured to:
compare the digital value to the second threshold; and
controllably disable the readout circuitry based on the comparison to the first threshold or the comparison to the second threshold.

18. The adaptive readout control circuitry of claim 17, wherein:
the readout operations comprise a high conversion gain (HCG) reset value RO, an HCG image value RO, a medium conversion gain (MCG) image value RO, an MCG reset value RO, a low conversion gain (LCG) image value RO, and an LCG reset value RO;
comparing the digital value to the first threshold comprises comparing a first digital value corresponding to an HCG reset value to the first threshold;
comparing the digital value to the second threshold comprises comparing a second digital value corresponding to an HCG image value to the second threshold; and
disabling the readout circuitry comprises:
in response to the first digital value being less than the first threshold, disabling the HCG image value RO, the MCG image value RO, and the MCG reset value RO; and
in response to the first digital value being greater than or equal to the first threshold:
in response to the second digital value being less than the second threshold, disabling the LCG image value RO and the LCG reset value RO; and
in response to the second digital value being greater than or equal to the second threshold, disabling the MCG image value RO, the MCG reset value RO, the LCG image value RO, and the LCG reset value RO.

19. The adaptive readout control circuitry of claim 16, wherein:
the readout circuitry comprises a column amplifier, an analog-to-digital converter (ADC), and a sample and hold circuitry; and
disabling the readout circuitry comprises disconnecting, from a voltage supply, the column amplifier, the ADC, or the sample and hold circuitry.

20. The adaptive readout control circuitry of claim 19, wherein:
the image sensor comprises a pixel having an output and a column line, wherein the column line is coupled with the output of the pixel;
the column line coupled with a current source and the readout circuitry; and
disabling the readout circuitry comprises disconnecting the column line from the current source.
